(19) United States
(12) Patent Application Publication
(10) Pub. No.: US 2005/0095185 A1
(43) Pub. Date: May 5, 2005

(54) Catalytic reactor, corresponding reaction installation and method

(75) Inventor: Daniel Gary, Montigny Le Bretonneux (FR)

Correspondence Address: AIR LIQUIDE, 2700 POST OAK BOULEVARD, SUITE 1800, HOUSTON, TX, 77056, US

(73) Assignee: L'Air Liquide, 75321 Paris (FR)

(21) Appl. No.: 10/499,929

(22) PCT Filed: Dec. 13, 2002
(86) PCT No.: PCT/FR02/04345

(30) Foreign Application Priority Data
Dec. 20, 2001 (FR) 01/16581

(51) Int. Cl. B01F 1/00

(52) U.S. Cl. 422/224; 422/225

(57) ABSTRACT

The invention concerns a catalytic reactor for reacting a mixture of a first gas and a second gas. It comprises a reaction chamber (28) including a catalytic reaction bed (64). It comprises an injection device (24) including first (42) and second (44) tubes supplying first and second gases. The first supply tube (42) bears a first inlet (10) and the second supply tube (44) bears a second inlet (12). The outlet (52) of the second tube (44) emerges in the first tube (42). The reactor further comprises a mixing device (26) which is connected to the injection device (24), which is arranged downstream of the outlet (52) of the second tube (44), and which emerges in the reaction chamber (28). The invention is useful for making synthesis gases.

The present invention relates to a catalytic reactor for reacting a homogeneous mixture, in particular inflammable, of a first and a second gas, of the type comprising
a reaction vessel in which a catalytic reaction bed is arranged, and
means for introducing the two gases into the reaction vessel.

It applies in particular to installations for producing synthesis gas.

Catalytic reaction installations are known in which a mixture of a combustible gas and an oxidizing gas is subjected to a partial oxidation by catalysis. Such installations are known for example from patents EP-A-0 931 842, EP-A-0 686 701, and U.S. Pat. No. 5,720,901.

In the installations of these patents, the homogeneous oxidizing/combustible gas mixture is conveyed, for example, from a tank, via a feed pipe, and is then injected into a catalytic reactor.

Since these mixtures are highly inflammable, a risk exists of auto-ignition of the mixture along the feed pipe, which is liable to cause a blast or even an explosion within the feed pipe or the catalytic reactor.

Furthermore, the art is familiar with static mixers of a gas with another gas. Examples of such mixers are described in patents EP-A-0 663 236 and EP-A-0 960 650. These mixers are used in particular to mix a cooling gas with a hot exhaust gas.

Other examples of mixers are described in patents EP-A-0 474 524 and EP-A-1 120 151. In these mixers, the second gas is injected into the first gas radially with respect to the flow of the first gas.

It is an object of the present invention to overcome the operating and safety drawbacks of the known catalytic reactors supplied with such fluids, and to propose a catalytic reactor with a safe feed system while incurring a low production cost.

For this purpose, a subject of the invention is a catalytic reactor of the aforementioned type, characterized in that the introduction means comprise an injection device comprising first and second feed tubes, in that said first feed tube bears a first inlet for said first gas and said second feed tube bears a second inlet for said second gas, in that said second feed tube comprises an outlet of said second gas discharging into said first feed tube, and in that the introduction means further comprise a mixing device which is connected to the injection device, which is arranged downstream of the outlet of said second feed tube, and which discharges into the reaction vessel.

According to other embodiments, the reactor may comprise one or more of the following features:
the mixing device is a static mixer comprising a tubular member and mixing elements;
the mixing elements comprise blades integral with the tubular member;
the mixing device comprises a packing arranged in the tubular member;
the packing is a structured packing;
the structured packing comprises a corrugated-crossed packing;
the reactor comprises a substantially laminar flow zone located immediately downstream of the mixing elements, this zone consisting of a tubular member;
the vertical clearance between the outlet of the laminar flow zone and the reaction bed is between 140 mm and 160 mm, for a vessel inside diameter of 160 mm;
the tubular member of the mixing device is arranged substantially coaxially with at least one of said feed tubes;
the mixing device is arranged inside the reaction vessel;
the mixing device is arranged adjacent to the reaction vessel and outside it;
said first and second feed tubes are arranged coaxially with one another, at least in the outlet zone of said second feed tube, and this outlet is directed coaxially with said first feed tube;
the gas flow in the reactor, during the operation thereof, has a general direction parallel to at least one of said feed tubes and this along substantially the whole length of the reactor;
the clearance between the outlet of said second tube and the mixing elements is between 0 mm and 50 mm;
the reactor comprises feed means of said first and second feed tubes able to convey the two gases at substantially identical speed, at least in the outlet zone of said second feed tube;
the reactor comprises a thermal insulation layer arranged between the reaction vessel and the reaction bed; and
the reactor is a reactor for a partial oxidation reaction.

A further subject of the invention is a catalytic reaction installation, characterized in that it comprises:
a catalytic reactor as defined above,
a source of oxidizing gas connected to said first inlet, and
a source of combustible gas connected to said second inlet.

A further subject of the invention is a method for chemically reacting two gases, particularly an oxidizing gas and a combustible gas, characterized in that it comprises the following successive steps:
a first flow of a first gas is introduced into the flow of a second gas to form a heterogeneous flow;
the heterogeneous flow passes through the mixing elements of a mixing device and is thereby homogenized;
the homogenized flow passes through a catalytic reaction bed in which the two gases produce a chemical reaction.

According to other embodiments, the method may comprise one or more of the following steps:
the flow speeds of the two gases are adjusted so that the residence time of the two gases in the mixing device is much shorter than the auto-ignition time of the mixture of the two gases, particularly shorter than 0.05 sec, and preferably shorter than 0.01 sec;
said first gas is introduced into the flow of said second gas in substantially laminar mode;
said first gas is introduced into the flow of said second gas in the flow direction of said second gas; and
said first gas is introduced into the flow of said second gas at a substantially identical speed for the two gases.

The invention will be better understood from a reading of the description below, given exclusively as an example and by reference to the attached drawings, in which:

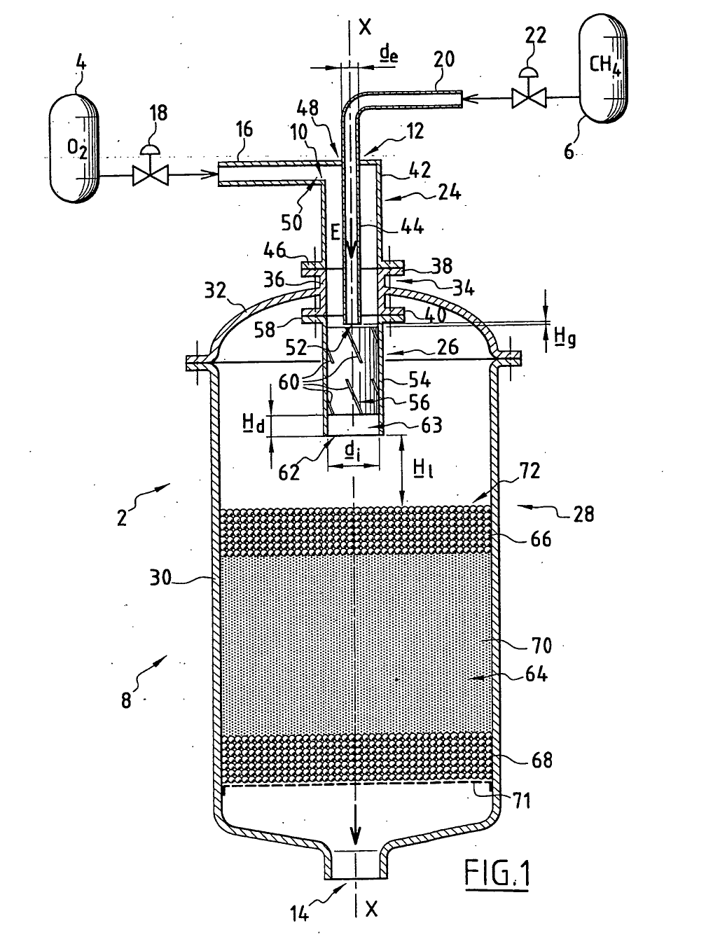

FIG. 1 is a longitudinal cross-section of a first embodiment of a catalytic reaction installation according to the invention;

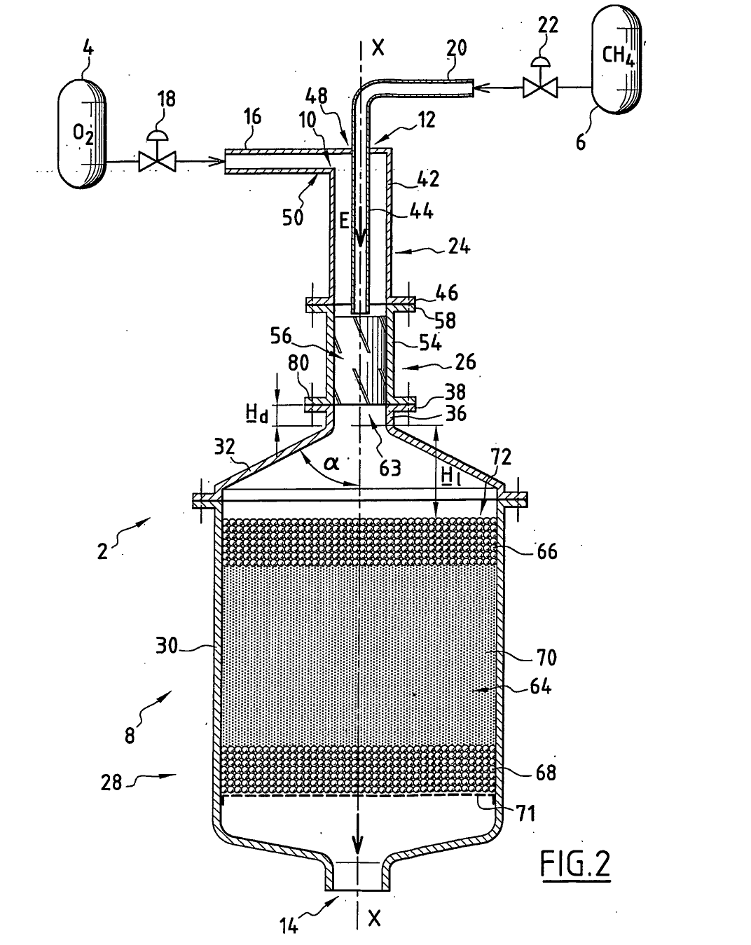

FIG. 2 is a schematic view of a catalytic reaction installation according to a second embodiment of the invention; and

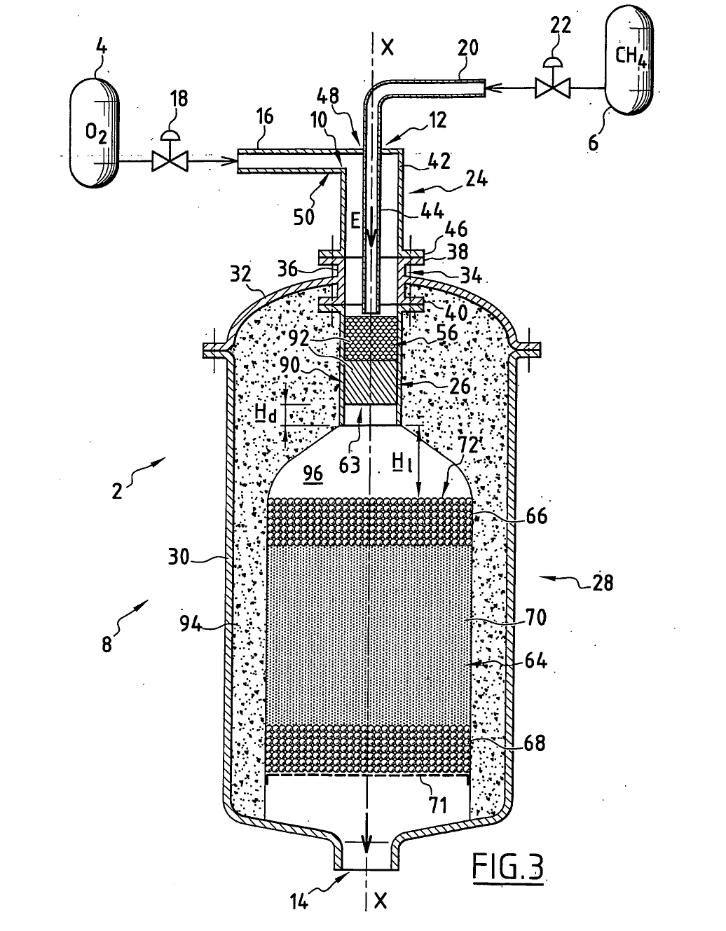

FIG. 3 is a schematic view of a third embodiment of a catalytic reaction installation according to the invention.

FIG. 1 shows a longitudinal cross-section of the catalytic reaction installation according to the invention, designated by the general numeral 2.

In the figures, the general flow direction of gas E is downflow. The gas inlets of the elements of the installation 2 are therefore located at their top ends, while the gas outlets are located at the bottom ends.

The installation 2 is designed to chemically react a mixture of an oxidizing gas and a combustible gas. The combustible gas is, for example, a light hydrocarbon from C₁ to C₅ or a mixture thereof, particularly of natural gas (essentially CH₄) or C₃H₈, whereas the oxidizing gas is, for example, a gas rich in O₂, such as air, O₂ or an O₂/N₂ mixture.

In the case of a mixture of CH₄ and air, the following partial oxidation reaction occurs inside the installation:
2CH₄+O₂>2CO+4H₂ (partial oxidation reaction of methane to produce synthesis gas).

The installation comprises an oxidizing gas source 4, in this case an oxygen tank, and a combustible gas source 6 such as a CH₄ tank. As a variant, the combustible gas source is a natural gas storage facility or network. The installation 2 further comprises a catalytic reactor 8 comprising an oxidizing gas inlet 10, a combustible gas inlet 12, and a reaction gas outlet 14.

The oxygen tank 4 is connected to the oxidizing gas inlet 10 via a first pipe 16 and a first valve 18. The CH₄ tank 6 is connected to the combustible gas inlet 12 via a second pipe 20 and a second valve 22.

The catalytic reactor 8 consists of an injection device 24, a mixing device 26 and a reaction vessel 28.

The reaction vessel 28 comprises a body or cylindrical metal shell 30 with a circular cross-section of central axis X-X, arranged vertically. The body 30 is substantially closed in its bottom portion, allowing the gas outlet 14 from the reactor to subsist. The vessel 28 further comprises a cover 32 screwed tightly on the upper portion of the body 30. A central opening 34 is arranged in the cover 32, coaxially with the X-X axis.

A tubular joint 36, extending coaxially with the central axis X-X, is welded tightly to the central opening 34 and passes through it. The tubular joint 36 comprises an upper 38 and lower 40 connecting flange at its two ends. The tubular joint 36 has an inside diameter dᵢ.

The injection device 24 comprises an external tube 42 with inside diameter dᵢ and an internal tube 44. The internal tube 44 has an outside diameter de smaller than the diameter dᵢ. The two tubes 42, 44 extend coaxially with the axis X-X.

The external tube 42 terminates at its bottom end in a flange 46, by which it is connected to the upper flange 38 of the tubular joint 36. The upper end 48 of the external tube is substantially closed.

An oxidizing gas feed orifice 50 is arranged in the side wall of the upper end 48 of the external tube. The first pipe 16 discharges into this feed orifice 50. The internal tube 44 passes through the upper end 48 of the external tube, and is connected to the second pipe 20.

The internal tube 44 extends across the tubular joint 36 and terminates in an outlet orifice 52 which discharges coaxially with axis X-X into an inlet of the mixing device 26.

The mixing device 26 is a static mixer. It consists of a tubular duct 54 and of mixing elements 56, arranged inside the duct 54. The duct 54 has a hollow circular-section cylindrical shape with inside diameter dᵢ and is fixed by a flange 58 to the lower flange 40 of the tubular joint 36. In this way, the mixing device 26 is located entirely inside the reaction vessel 28.

The inside diameters dᵢ of the external tube 42, of the tubular joint 36 and of the duct 54 are identical.

The mixing elements 56 consist of two layers of four blades 60, the two layers being axially distant from one another. The blades 60 project from the inside wall of the duct 54 and have a general helical shape.

The outlet orifice 52 of the internal tube 44 is arranged adjacent to the upper end of the mixing elements 56. Between the outlet 52 of the internal tube 44 and the mixing elements 56, a clearance H_{g} subsists, which, for example, is between 0 mm and 50 mm.

The lower end 62 of the mixing device 26, which is the outlet thereof, is devoid of mixing elements 56 along an axial height H_{d}, and forms a laminar gas flow zone 63.

The reaction vessel 28 further contains a reaction bed 64 covering the entire cross-section of the vessel 28. The reaction bed 64 consists of two layers of upper 66 and lower 68 thermal barrier, and a median layer 70 of catalyst. The two upper 66 and lower 68 layers consist of beads of aluminum oxide, and extend, for example, along an axial height of 150 mm. The median layer 70 consists of granules of a ceramic support, coated with platinum or rhodium. As a variant, other materials can be used for the thermal barrier or the catalyst.

The reaction bed 64 is supported by a support grid 71 integral with the shell 30.

Between the lower end 62 of the duct 54 and a free surface 72 of the upper layer 66 a vertical clearance Hₗ subsists, which promotes additional homogenization of the oxidizing gas/combustible gas mixture. The vertical clearance Hₗ is, for example, between 140 mm and 160 mm, for a shell inside diameter of 160 mm.

The components of the catalytic reactor 8, unless otherwise indicated, consist preferably of special alloys such as Z5 NC32-21 (“HASTELLOY”) or of any other suitable material.

The installation according to the invention operates as follows:

The oxidizing gas inlet 10 and the combustible gas inlet 12 are supplied with oxygen and CH₄ respectively. If necessary, the gases are preheated, for example to 300° C., and pressurized, for example, to 8 to 12 bar. The oxygen, as the oxidizing gas, is introduced into the external tube 42 via the feed orifice 50 and flows in substantially laminar mode coaxially with the axis X-X. The CH₄, as the combustible gas, also flows in a substantially laminar mode and in the same direction as the oxygen, in the internal tube 44 up to the outlet orifice 52. It should be observed that the risks of auto-ignition of such a mixture are greater at higher service temperature and/or pressure. At high temperature, these mixtures are auto-inflammable. A flame can be initiated without the presence of any other external ignition source.

At the outlet orifice 52, the CH₄ is introduced coaxially and in the same direction as the oxygen flow, and a heterogeneous CH₄/oxygen mixture is formed. The flow speeds of the gases are preferably selected so that they are substantially identical at the location of the outlet orifice 52. In consequence, the creation of a mixture does not occur upstream of the mixing device 26, so that the risk of auto-ignition of the mixture is avoided.

The heterogeneous CH₄/oxygen mixture immediately enters the mixing device 26.

The heterogeneous mixture is entrained in turbulent rotation by the blades 60 and is homogenized so that a homogeneous CH₄/oxygen mixture is produced on the cross-section of the mixing device 26. At the outlet of the mixing elements 56, the mixture has a mean mixture concentration difference of less than 5%, measured along the cross-section of the mixer. The residence time of the gas in the mixing device 26 is very short, shorter than the auto-ignition time of the mixture. The residence time is typically shorter than 0.05 sec and preferably shorter than 0.01 sec, so that the risk of auto-ignition of the mixture in the mixing device 26 is very low or nil. The turbulent flow is converted into a substantially laminar flow in the laminar flow zone 63.

The vertical clearance Hₗ which subsists between the outlet of the mixing device 26 and the upper surface 72 of the bed enables the homogeneous mixture to increase its homogeneity. At the location of the upper surface 72 of the reaction bed, the mixture has a mean concentration difference of less than 3%, and preferably less than 2%.

The homogeneous mixture then flows along the X—X axis through the upper thermal barrier layer 66 and enters the catalysis layer 70. In the catalysis layer 70, the aforementioned reaction then takes place:
2CH₄+O₂=>2CO+4H₂.

Since the gas mixture at the inlet of the reaction bed 64 is very homogeneous, the formation of hot spots or solid carbon deposits, according to the reactions CH₄+2O₂=>CO₂+2H₂O and/or CH₄+O₂=>C+2H₂O, is prevented or very slight. The risk of damage to the reactor 8 by overheating or clogging is therefore low.

The synthesis gas CO+H₂ passes through the lower thermal barrier layer 68 and is withdrawn at the reactor outlet 14.

The static mixing device 26 is compact, cheap and has a low pressure drop. It equalizes the concentration and, if applicable, the gas speeds and their temperatures over a short flow distance. In consequence, the formation of detonation cells in the mixing device 26 is prevented, providing it with enhanced safety.

The installation 2 is very safe, since the oxidizing/combustible gases are stored and conveyed separately. The risk of auto-ignition of the mixture in a common feed pipe is therefore avoided.

FIG. 2 shows a second embodiment of the catalytic reaction installation 2 according to the invention. Only the differences to the first embodiment are described. The analogous elements bear identical numerals.

The tubular joint 36 of the cover 32 only extends on the external side of the cover 32. This joint 36 has an axial height H_{d} and bears the upper flange 38 at its upper end. The cover 32 is a truncated cone, widening towards the reaction bed 64. The opening angle α between the central axis X-X and the frustum of the cone is selected so that the gas mixture flows in substantially laminar mode into the cover 32.

Furthermore, the mixing device 26 is located outside the reaction vessel 28 and directly adjacent to it. It is inserted between the injection device 24 and the cover 32. For this purpose, the duct 54 of the mixing device 26 comprises a lower flange 80 connected to the upper flange 38 of the cover 32. The mixing elements 56 are flush with this lower flange 80.

The flange 46 of the injection device 24 is connected to the upper flange 58 of the duct 54. The internal tube 44 is shortened with respect to the first embodiment, since the mixing elements 56 of the mixing device 26 are arranged adjacent to the flange 46 of the external tube 42.

The operation of this installation 2 is similar to that of the first embodiment.

As one difference, the tubular joint 36 of the cover acts as a laminar flow zone 63.

FIG. 3 shows a third embodiment of an installation according to the invention.

This installation differs from that of the first embodiment in the following points.

The mixing elements 56 of the mixing device 26 consist of a structured corrugated-crossed packing 90. The packing 90 comprises two layers 92 of corrugated-crossed plates with a general vertical plane, angularly offset by 90° from one another about the X-X axis. Examples of corrugated-crossed packings are described in patents CA-A-1 095 827 and EP-A-0 158 917.

Furthermore, the reaction bed 64 has a smaller diameter than the inside diameter of the shell 30. The annular space between the reaction bed 64 and the shell is filled with a thermal insulation layer 94.

The thermal insulation layer 94 is a rigid self-supporting unit consisting for example of a refractory material such as alumina. The thermal insulation layer 94 extends along the axial direction between the two ends of the vessel 28. The space extending between the mixing device 26 and the vessel 28 is also filled with the thermal insulation layer 94. This layer, in its upper portion, matches the shape of the cover 32 and of the mixing device 26. However, between the outlet of the mixing device 26 and the upper surface 72 of the reaction bed, an empty space 96 subsists, substantially in the form of a truncated cone, widening towards the reaction bed 64, which allows the substantially laminar flow and the distribution of the gas mixture throughout the cross-section of the bed.

The thermal insulation limits the heat losses of the gas mixture. Thus, endothermic chemical reactions that may be necessary in the bottom portion of the median layer 70 can take place without any external heat input.

1-23. (canceled)

24. An apparatus which may be used for reacting an inflammable, homogenous mixture of a first and a second gas comprising:
a) a reaction vessel wherein a catalytic reaction bed is arranged; and
b) a means for introducing said gases into said vessel, said means further comprising:
1) an injection device, said injection device further comprising:
i) a first feed tube further comprising an inlet for said first gas; and
ii) a second feed tube further comprising:
aa) an inlet for said second gas; and
bb) an outlet for said second gas which discharges into said first feed tube thereby forming a first heterogeneous mixture of said first and said second gases; and
2) a mixing device connected to said injection device downstream of said second feed tube outlet wherein said mixing device receives said heterogeneous mixture and discharges a homogenous mixture to said reaction vessel.

25. The apparatus of claim 24, wherein said mixing device is a static mixer comprising:
a) a tubular member; and
b) mixing elements.

26. The apparatus of claim 25, wherein said mixing elements further comprise blades integral with said tubular member.

27. The apparatus of claim 25, wherein said mixing device further comprises a packing located in said tubular member.

28. The apparatus of claim 27, wherein said packing further comprises a structured packing.

29. The apparatus of claim 28, wherein said structured packing further comprises a corrugated-crossed packing.

30. The apparatus of claim 25, further comprising a substantially laminar flow zone located immediately downstream of said mixing elements, wherein said zone further comprising a tubular member.

31. The apparatus of claim 25, wherein said reaction vessel has an inside diameter of about 160 mm.

32. The apparatus of claim 31, wherein the vertical clearance (by) between the outlet of said laminar flow zone and said reaction bed is between about 140 mm and about 160 mm.

33. The apparatus of claim 25, wherein said tubular member of said mixing device is substantially located coaxially with at least one said feed tube.

34. The apparatus of claims 24, wherein said mixing device is located inside said reaction vessel.

35. The apparatus of claim 24, wherein said mixing device is located outside of and adjacent to, said reaction vessel.

36. The apparatus of claim 24, wherein said first and said second feed tubes are located coaxially with each other.

37. The apparatus of claim 36, wherein said outlet zone of said second feed tube is located coaxially with said first feed tube.

38. The apparatus of claim 24, wherein the gas flow (E) in said reactor has a general direction, along substantially the whole length of said reactor, which is parallel to at least one of said feed tubes.

39. The apparatus of claim 25, wherein the clearance (H_{g}) between said outlet of said second tube and said mixing elements is between about 0 mm and about 50 mm.

40. The apparatus of claim 24, further comprising a feed means for said first and said second feed tubes wherein said feed means conveys said gases at substantially identical speed in said outlet zone of said second feed tube.

41. The apparatus of claim 24, further comprising a thermal insulation layer located between said vessel and said bed.

42. The apparatus of claim 24, wherein said reaction is a partial oxidation reaction.

43. An apparatus which may be used as a catalytic reaction installation comprising:
a) a reactor suitable for reacting an inflammable, homogenous mixture of a first and a second gas, said reactor further comprising:
1) a reaction vessel wherein a catalytic reaction bed is arranged; and
2) a means for introducing said gases into said vessel, said means further comprising:
i) an injection device, said injection device further comprising:
aa) a first feed tube further comprising an inlet for said first gas; and
bb) a second feed tube further comprising:
1′) an inlet for said second gas; and
2′) an outlet for said second gas which discharges into said first feed tube thereby forming a first heterogeneous mixture of said first and said second gases; and
ii) a mixing device connected to said injection device downstream of said second feed tube outlet wherein said mixing device receives said heterogeneous mixture and discharges a homogenous mixture to said reaction vessel; and
b) an oxidizing gas source connected to said first inlet; and
c) a combustible gas source connected to said second inlet.

44. A method of reacting an oxidizing gas and a combustible gas comprising the following successive steps:
1) introducing a first flow of a first gas into a second flow of a second gas to form a heterogeneous flow;
2) homogenizing said heterogeneous flow by passing said flow through the mixing elements of a mixing device; and
3) passing said homogeneous flow through a catalytic reaction bed to produce a chemical reaction.

45. The method as claimed in claim 43, wherein the flow velocity of said gases are adjusted so that the residence time of said gases in said mixing device is less than the auto-ignition time of the mixture of said gases.

46. The method of claim 44, wherein said residence time is less than about 0.05 sec.

47. The method of claim 45, wherein said residence time is less than about 0.01 sec.

48. The method of claim 43, wherein said first gas is introduced into said second flow in a substantially laminar mode.

49. The method of claim 43, wherein said first gas is introduced into said second flow in the flow direction of said second gas.

50. The method of claim 43, wherein said first gas is introduced into the flow of said second gas at substantially the same velocity for said gases.
